(19) United States
(12) Patent Application Publication
(10) Pub. No.: US 2011/0113242 A1
(43) Pub. Date: May 12, 2011

(54) PROTECTING MOBILE DEVICES USING DATA AND DEVICE CONTROL

(75) Inventor: Stephen McCormack, Dublin (IE)

(73) Assignee: Beyond Encryption Limited, Dublin (IE)

(21) Appl. No.: 12/797,367

(22) Filed: Jun. 9, 2010

Related U.S. Application Data
(60) Provisional application No. 61/185,508, filed on Jun. 9, 2009.
(60) Provisional application No. 61/187,935, filed on Jun. 17, 2009.

(51) Int. Cl. G06F 12/14; G06F 17/30; G06F 1/00

(52) U.S. Cl. 713/165; 726/26; 726/28; 713/300

(57) ABSTRACT

A method for securing data on a mobile device includes establishing a remote connection between a server and a mobile device, receiving at the server a directory listing from the mobile device indicating files and folders stored on the mobile device, selecting one or more files or folders for securing on the mobile device, and transmitting from the server a secure command to the mobile device instructing the mobile device to secure the selected one or more files or folders. A system including a server and a mobile device can perform the method.

### REFERENCE TO RELATED APPLICATIONS

This application claims the priority of U.S. Provisional Patent Application No. 61/185,508, filed on Jun. 9, 2009, and U.S. Provisional Patent Application No. 61/187,935, filed on Jun. 17, 2009, the contents of which are herein incorporated by reference.

### FIELD OF THE DISCLOSURE

This generally relates to techniques and systems for securing mobile devices and the data on these devices.

### BACKGROUND

Organizations whose employees use mobile devices such as laptops and smart phones can place sensitive data stored on these devices at risk. Whereas in the past sensitive data has been stored in stationary computers on the premises of an organization, now sensitive data can be spread over a large geographic area. Further, the security of the mobile device is largely left up to the individual employee possessing the device. The unsecured nature of these devices can increase the risk of unauthorized access, exposure of sensitive information, disruption of service, or failure to comply with regulatory requirements.

When a device has been lost or stolen, the data stored on it can become compromised. Password protection of the device has been a popular method of securing the device against a third party. Password protection, however, keeps the responsibility for securing sensitive data stored on the device with one of the weakest links in the security chain—the device user/employee. Successful data protection thus depends on these individuals fully adopting the security solution by following corporate policy and performing key tasks such as powering down laptops and using a strong password. Unfortunately, many employees do not fully adopt the security solution and their mobile devices can thus be security risks.

Additionally, traditional security infrastructures, such as password protection, have been primarily designed to protect against external threats. Today, however, the more imminent and pernicious threats to information security can come from inside the enterprise, within what was traditionally the secure perimeter. Employees have access to sensitive data, password protection obviously does not stop them, and, because of the mobility of mobile devices, they can operate in an environment outside of the organization's premises where their malicious activity is less likely to be noticed in time.

### SUMMARY

A method for securing data on a mobile device includes establishing a remote connection between a server and a mobile device, receiving at the server a directory listing from the mobile device indicating files and folders stored on the mobile device, selecting one or more files or folders for securing on the mobile device, and transmitting from the server a secure command to the mobile device instructing the mobile device to secure the selected one or more files or folders.

A mobile device includes a memory configured to store files and folders a communication unit configured to connect to a server, a directory listing module configured to transmit to the server a directory listing indicating the stored files and folders, and a security module configured to secure one or more of the stored files and folders based on a secure command received from the server.

A system includes a server and a mobile device. The system further includes a memory on the mobile device storing files and folders, a first communication unit on the mobile device configured to transmit to the server a directory listing indicating the files and folders stored on the mobile device, a user interface on the server configured to display the transmitted directory listing and a plurality of commands and to receive a selection of one or more files or folders indicated by the directory listing and a selection of one of the plurality of commands, a second communication unit on the server configured to transmit to the mobile device an instruction comprising the selected one or more files or folders and the selected command, and a client agent on the mobile device configured to secure the selected one or more files or folders by executing the transmitted instruction.

### BRIEF DESCRIPTION OF THE DRAWINGS

FIG. 1 illustrates an example of a system infrastructure according to an embodiment.

FIG. 2 illustrates an example of a process for entering a secure portion of an administrator interface.

FIG. 3 illustrates an example of a process for transmitting security information between a server and a client.

FIG. 4 illustrates an example of a graphical user interface in reactive security mode.

FIG. 5 illustrates an example of a process for selecting and executing a quarantine command.

FIG. 6 illustrates an example of a process for selecting and executing a delete command.

FIG. 7 illustrates an example of a process for selecting and executing a transfer command.

FIG. 8 illustrates an example of a process for selecting and executing a lock command.

FIG. 9 illustrates an example of a graphical user interface for selecting between reactive security mode and timed security mode.

FIG. 10 illustrates an example of a graphical user interface in timed security mode.

FIG. 11 illustrates an example of a graphical user interface displaying various information.

FIG. 12 illustrates an example of a computing device.

### DETAILED DESCRIPTION

Described are systems and methods for enforcing data security on a mobile device. The mobile device can be any of numerous computing devices, such as a cellular phone, smart phone, personal digital assistant (PDA), laptop, netbook, integrated computer (e.g., integrated in a vehicle), and the like. The systems and methods can integrate seamlessly with an organization's current computing and security infrastructure. Instructions can be remotely sent to the mobile device to perform various commands that can help to preserve the security of the mobile device. The commands can target the mobile device as a whole or particular files and folders stored on the mobile device to protect the organization's sensitive information. A user interface can facilitate the management of the mobile device and can deploy the various commands from a remote location.

The system can include various commands to secure data on the mobile device. A remote secure quarantine command can be used to encrypt specified folders and files stored on the mobile device. A remote secure deletion command can be used to delete specified folders and files stored on the mobile device. A remote secure file transfer command can be used to covertly transfer specified folders and files from the mobile device to the server. A remote secure lock command can be used to effectively deny a user access to all information stored on the device.

These security commands can be executed immediately or can be deferred. A command can be set to execute after a specified amount of time, after the occurrence of an event, or after a specified amount of time after occurrence of the event. Events that can trigger execution of the command can include failure of the mobile device to connect to a server, failure of the mobile device to connect to one or more specified Internet Protocol (IP) addresses, and failure of the mobile device to stay within a specified geographic area (or failure to stay out of a specified geographic area). In addition, surveillance of a user and/or the user's actions on the mobile device can be conducted from a remote location via the mobile device itself.

In the following description of embodiments, reference is made to the accompanying drawings which form a part hereof, and in which it is shown by way of illustration example embodiments in which the invention may be practiced. It is to be understood that other embodiments may be utilized and structural changes may be made without departing from the scope of the invention. In addition, numerous currently-available systems and software are identified only as examples that can be used to accomplish or perform a particular task. Numerous other systems, software, and techniques are available or can be designed by one or ordinary skill in the art to perform the various tasks, and these are included within the scope of the following embodiments.

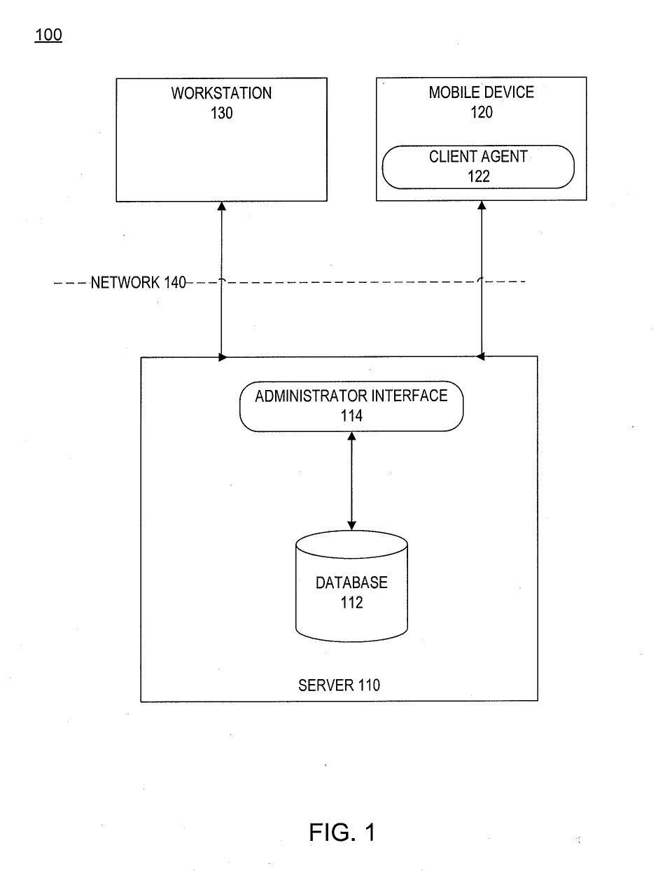

FIG. 1 illustrates an exemplary system infrastructure according to an embodiment. System 100 can include server 110, mobile device 120, work station 130, and network 140.

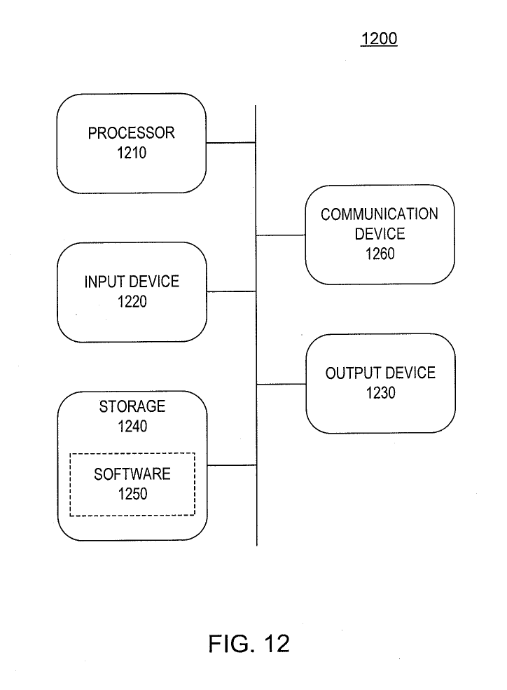

Server 110 can be implemented on one or more computing devices, as described with respect to FIG. 12 for example. In an embodiment, functionality of server 110 can be implemented using any of numerous server programming platforms. For example, a JBoss Seam web application framework running on an underlying Java Enterprise Edition-based application server program can be used in an embodiment. Seam can be a useful framework because it can provide a secure server environment with various authentication features.

Server 110 can include database 112 and can deploy administrator interface 114. Database 112 can store information regarding multiple devices that are managed using administrator interface 114, such as mobile device 120. Database 112 can store device identification information, user account information, file and directory information, and status information, for example. Database 112 can be created and implemented using any of numerous database management systems or can be programmed by one of ordinary skill in the art. In an embodiment, database 112 can be implemented using a relational database management system built on the MySQL platform, which can provide useful access control features.

Server 110 can provide various network services for managing remote devices, such as assigning policies, deploying software, applying updates, managing e-mail, and maintaining parallel directories of files and folders stored on managed mobile devices. For example, in an embodiment, server 110 can integrate with Microsoft's Active Directory, which can provide many of these services.

Administrator interface 114 can facilitate management of account information, policies, and settings associated with mobile device 120. Further, administrator interface 114 can issue special security commands or instructions to mobile device 120. In an embodiment, administrator interface 114 can include a web-based user interface that can be accessed via a web browser from computer workstation 130. In an embodiment, workstation 130 can be part of a local network with server 110.

Communications among the various system components can be secured and authenticated using numerous techniques. For example, the Secure Remote Password protocol can be implemented between workstation 130 and server 110 to ensure authentication and a secure communication channel. Additionally, system 100 can use Secure Sockets Layer or Transport Layer Security technology to encrypt communications between the various system components. This can include employing a public key infrastructure using digital certificates. Secure communication channels can be established between system components over network 140. Network 140 can comprise wired communication lines and/or wireless communication links such as wireless fidelity (WiFi). In an embodiment in which server 110 is implemented on multiple computers, communications between the computers can be secured as well.

Administrator Interface 114 can have two modes of operation: Normal mode and Alert mode. Normal mode can permit the day to day maintenance and administration of the system. When an administrator wishes to send a special security command to a target data device containing a client agent, such as mobile device 120, administrator interface can enter into Alert mode.

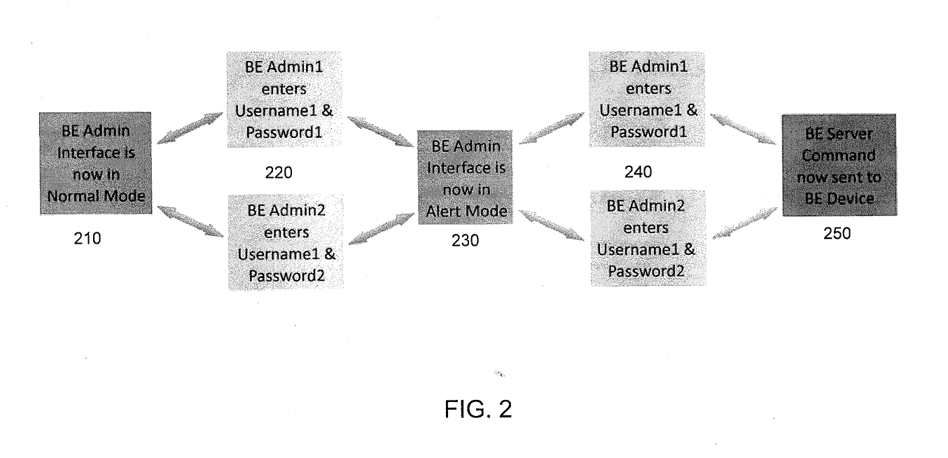

To ensure security of the system, administrator interface 114 can support Role Based Authentication, which is a security feature that can restrict actions taken by users to only those that fall within the user's predetermined role. To further protect against misuse of the special security commands, entering the system into Alert mode can require that two system administrators log onto administrator interface 114. As depicted in FIG. 2, changing from Normal mode (210) to Alert mode (230) can require that both administrators enter their user names and passwords (220). To actually send a special security command (250) from server 110 to mobile device 120, administrator interface can further require that each administrator re-enter their credentials (240). Alert mode can be disabled by either administrator simply logging off.

Mobile device 120 can be any of numerous computing devices. For example, mobile device 120 can be a cellular phone, smart phone, PDA, laptop, netbook, integrated computer (e.g., integrated in a vehicle), and the like. Mobile device can comprise client agent 122. Client agent 122 can be a client-side application program designed to communicate with server 110.

Client agent 122 can leverage the features and services of the underlying operating system of mobile device 120. Client agent 122 can run on mobile device 120 with reduced non-administrative privileges during normal operation. However, client agent 122 can run with administrative privilege when necessary, such as to execute a special security command received from server 110.

For example, in an embodiment, if the operating system is based on the Microsoft Windows platform, client agent 122 can maintain a secure operating environment by using the security features of Access Control Lists (ACLs), which can control access to information stored on the device, such as files, digital certificates, keys, and passwords. Further, interaction between client agent 122 and a user via the mobile device's user interface can be managed using the CredUIPromptForCredentials( ) function, which can authenticate a user before permitting communication with client agent 122.

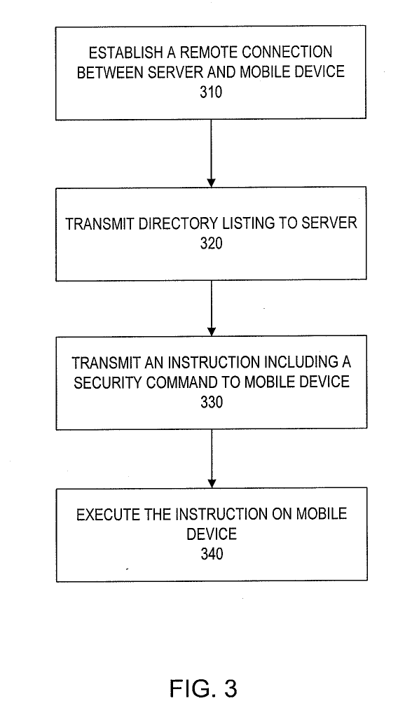

FIG. 3 illustrates an exemplary process that can be executed by server 110 and mobile device 120.

A remote connection can be established (310) between server 110 and mobile device 120. In an embodiment, a request for connection can be sent by server 110 to mobile device 120. In another embodiment, mobile device 120 can request connection with server 110 as part of a reporting routine in which mobile device 120 regularly updates server 110 on the status of mobile device 120.

Mobile device 120 can transmit a directory listing (320) of one or more files and folders stored on mobile device 120 to server 110. The directory listing can include all files and folders stored on mobile device 120, files with certain extensions, files and folders with certain names or within certain folders, and the like. Server 110 can integrate with Active Directory

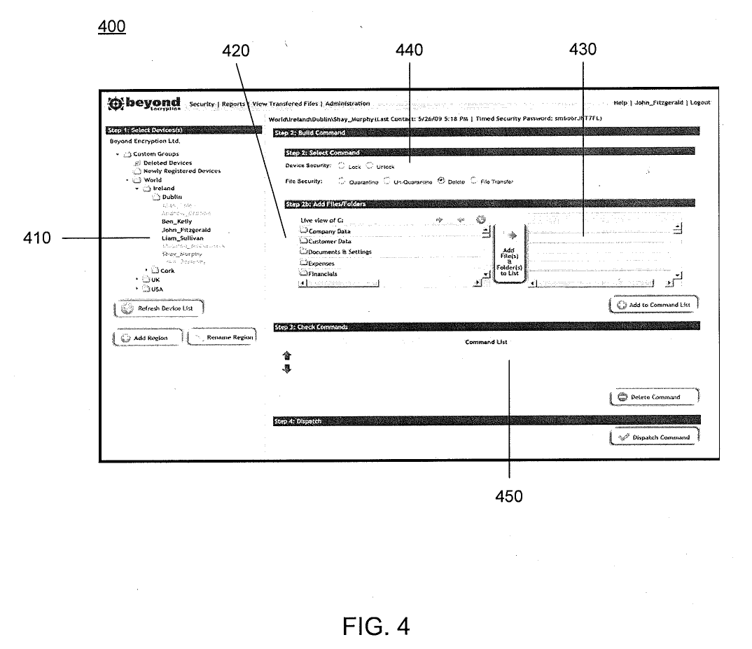

The transmitted directory listing can be displayed via a graphical user interface of administrator interface 114. A screenshot of an exemplary graphical user interface 400 is depicted in FIG. 4. Graphical user interface 400 can display a sub-list 410 of mobile devices currently managed by administrator interface 114. The directory listing of each managed mobile device can be displayed in directory listing portion 420. An administrator can navigate through the directory listing and select target folders and files, which can then be displayed in list 430.

An instruction including a special security command can be transmitted (330) from server 110 to mobile device 120. One or more special security commands can be selected from graphical user interface 400, as described below. In addition, other settings and additional commands can be included in the transmitted instruction, as described below.

In an embodiment, client agent 122 on mobile device 120 can have a unique hash identifier stored securely in client agent 122. When server 110 sends an instruction to mobile device 120, server 110 can generate a copy of the client hash identifier and include it in the transmitted instruction. Client agent 122 can compare its unique hash identifier with the hash identifier included in the instruction to verify that the instruction is genuine.

Upon receipt of an instruction by client agent 122 of mobile device 120, and after any authentication procedures, the instruction can be executed 340. Execution of the special security command included in the instruction can be accomplished without intervention by a user of mobile device 120. Further, client agent 122 can be configured such that execution of the command cannot be stopped, as described below.

The transmitted instruction can include one or a combination of the commands indicated in command portion 440 of graphical user interface 400: quarantine, deletion, file transfer, and lock.

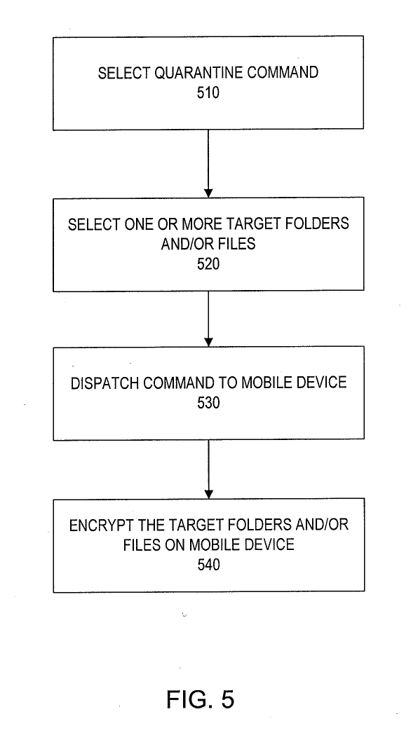

FIG. 5 illustrates a remote secure quarantine command that can secure specific folders and files stored on mobile device 120. The quarantine command can be selected (510) via command portion 440. One or more folders or files can be selected (520) via directory listing portion 420. The command can be added to command list 450 and dispatched (530) from server 110 to mobile device 120.

Upon receiving the quarantine command, the client agent 122 can encrypt the selected files and/or folders (540). Various encryption techniques can be used. For example, in an embodiment, client agent 122 can encrypt the selected files and/or folders using an Advanced Encryption Standard (AES) algorithm running in cipher block chaining and a randomly generated key with a key length of at least 256 bits. This action can thus prevent a user from accessing the remotely quarantined data files without removing the data files from mobile device 120. This may be a good option if it is unclear whether a mobile device is at risk.

In an embodiment, in order to prevent the quarantine process from being interrupted, either deliberately or accidentally, by powering down mobile device 120, an encryption key used to securely encrypt the target files can be stored securely on mobile device 120. In an embodiment, the Microsoft Data Protection Application Programming Interface can be employed to accomplish this. Should power to mobile device 120 be interrupted during the quarantine process, the encryption routine can continue when mobile device 120 restarts by using the locally stored encryption key. The encryption key can be deleted from mobile device 120 once the quarantine process has completed. This can ensure that only the organization, through server 110, has the ability to control the quarantine process.

If the security of mobile device 120 is later verified, administrator interface 114 can take the selected protected files out of quarantine by transmitting an un-quarantine command. Upon receiving an un-quarantine command from server 110, client agent 122 can decrypt the target files and/or folders using the decryption method corresponding to the encryption method previously used. This action can re-enable user access to the previously remotely quarantined data files.

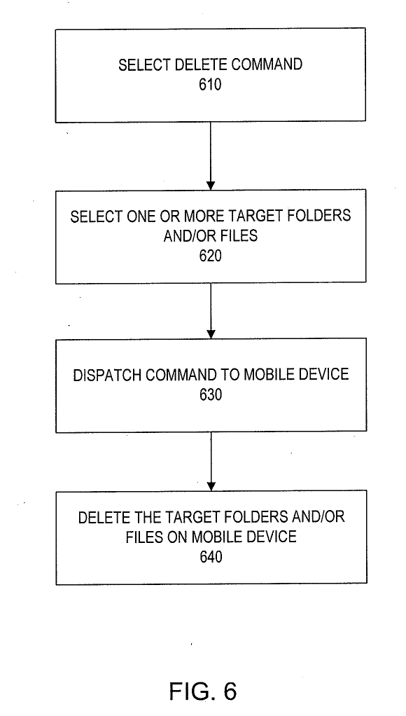

FIG. 6 illustrates a remote secure delete command that can protect specific files and/or folders. The delete command can be selected (610). One or more folders or files can be selected (620). The command can then be dispatched (630) to mobile device 120. Upon receiving the delete command, client agent 122 can delete the selected files and/or folders (640). In an embodiment, once the delete command has been received by client agent 122, it cannot be interrupted by a user. Additionally, if power to the device is interrupted, the deletion routine can continue when the device restarts until the routine is completed.

In an embodiment, client agent 122 can delete the targeted files by overwriting them at least once with patterned and randomized data. The deletion procedure can be performed to comply with the US Department of Defense clearing and sanitizing standard. In addition, the delete command can also cause to be deleted various system files used for temporary storage of file information. For example, in a Microsoft Windows-based system, Pagefile.sys, which is a virtual page file, and Hiberfil.sys, which is a file storing an image of a current state of temporary memory to assist in a hibernation operation, can be deleted to ensure that any cached information has been securely removed.

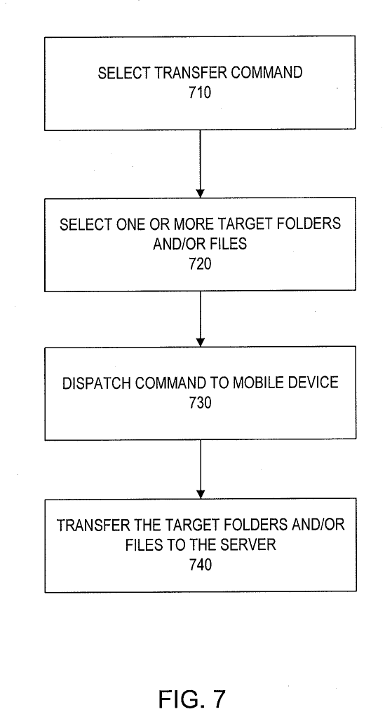

FIG. 7 illustrates a remote secure transfer command that can protect specific files and/or folders. The transfer command can be selected (710). One or more folders or files can be selected (720). The command can then be dispatched (730) to mobile device 120. Upon receiving the transfer command, client agent 122 can transfer the selected files and/or folders from mobile device 120 to server 110 (740).

In an embodiment, this command can be used in conjunction with another command, such as remote secure quarantine or remote secure delete, to prevent user access to the files after they have been transferred. In such a case, the file transfer command can be given precedence over the other command. The file transfer can be executed transparently such that a user of mobile device 120 is unaware that a security action is being executed.

In an embodiment, when the file transfer command is received from server 110, client agent 122 can automatically encrypt the target files and/or folders, as described above with respect to the quarantine command. When the target files and/or folders are encrypted, they can then be compressed and securely transferred from mobile device 120 to server 110. Upon receipt, server 110 can decompress and decrypt the transferred data.

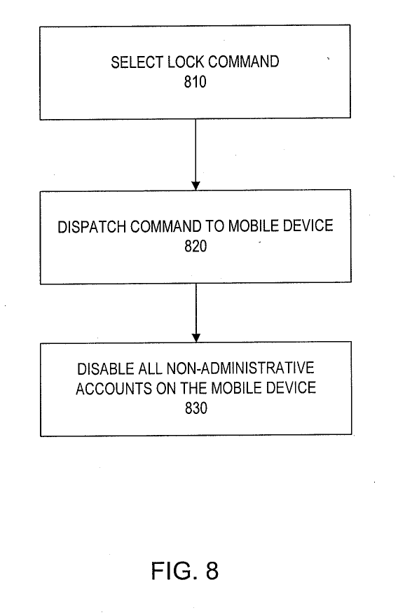

FIG. 8 illustrates a remote secure lock command that can be used to secure mobile device 120. The lock command can be selected (810). No files and/or folders need to be selected as the lock command is intended to prevent user access to mobile device 120 generally. The lock command can then be dispatched (820) to mobile device 120. Upon receiving the lock command, client agent 122 can disable all the non-administrative user accounts (830) on mobile device 120. In an embodiment, the lock command can further cause client agent 122 to reset the local administrator password and/or shut the device down.

Mobile device 120 can be unlocked by sending an unlock command from server 110. The unlock command can re-enable the non-administrative user accounts. In an embodiment, a temporary password can be provided to a user to temporarily unlock mobile device 120 if the need should arise. The user could receive the password in person from an administrator or the user could directly contact an administrator via telephone or a computing device other than mobile device 120, for example, to receive the password.

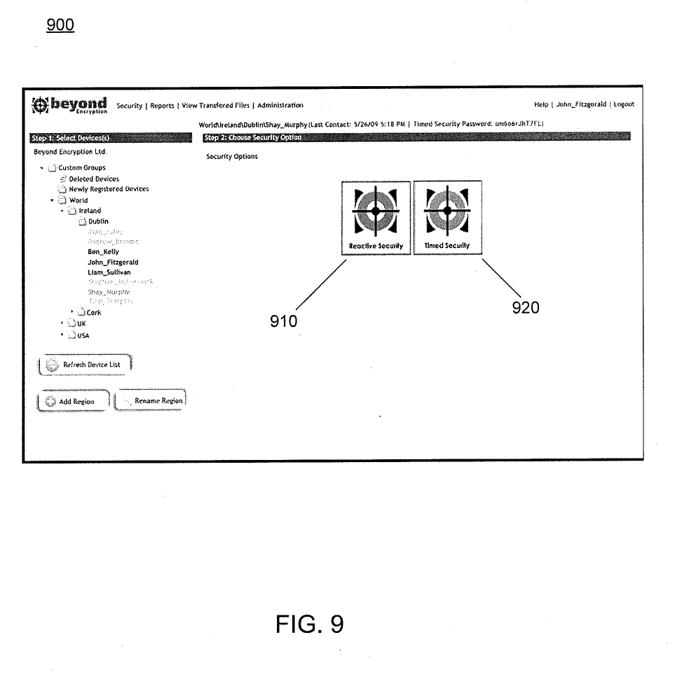

The special security commands can be enabled to execute immediately or after a predetermined amount of time. FIG. 9 is a screenshot of an exemplary graphical user interface 900 corresponding to a state of administrative interface 114 depicting a reactive security mode 910 and a timed security mode 920. The administrators can select the desired mode for deploying the security commands.

FIG. 4, as described earlier, illustrates the command options in reactive security mode. Commands issued in reactive security mode can be executed immediately by client agent 122. Reactive security mode can be used, for example, when it is likely that a security breach has already occurred. In an embodiment, a portion of the code necessary to execute a reactive command can be omitted from client agent 122. The omitted portion, in the form of a dynamic-link library file, for example, can be included in the instruction transmitted to mobile device 120 from server 110. This can prevent the unauthorized execution of a reactive security command. In an embodiment, client agent 122 can require a passcode before executing a security command. The passcode can be included in the transmitted instruction along with the security command.

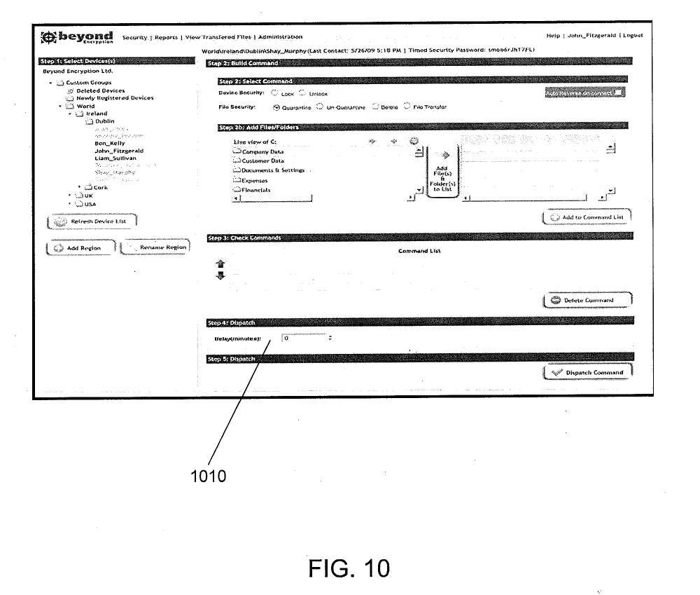

FIG. 10 illustrates the command options in timed security mode. The significant difference between reactive security mode and timed security mode is that the administrators can specify a time limit in timed security mode, via delay portion 1010 for example. The time limit can be associated with the timed security command included in the instruction transmitted to mobile device 120.

Thus, timed security commands can operate as a pre-configured security policy for mobile device 120. This pre-configured security policy can configure client agent 122 to execute any of the special security commands after a period of time. Thus, the timed security command can cause mobile device 120 to enter into a timed security mode. In an embodiment, a timed security command can be associated with the occurrence of a specific event. For example, a timed security command can be set to execute if mobile device 120 does not connect to server 110 within a predetermined period of time. Other example triggering events are discussed below. A specific triggering event can be set as a default in mobile device 120, can be set as a default when in timed security mode, or a triggering event can be selected via administrator interface 114.

The predetermined period of time can be measured using a clock/timer of mobile device 120. The timed security mode can be set to automatically de-activate and clear the clock/timer when mobile device 120 reconnects to server 110. Upon a subsequent disconnection from server 110, timed security mode can be triggered again and the clock/timer can restart. In an embodiment, the transmitted instruction can specify how many times mobile device 120 should enter into timed security mode. In an embodiment, a timed security command and/or entry of mobile device 120 into timed security mode does not affect a reactive security command. For example, a reactive lock command can be transmitted to and executed by mobile device 120 even though mobile device 120 may be in timed security mode. In addition, the timed security settings can be updated anytime that mobile device 120 is connected to server 110.

In an embodiment, client agent 122 can maintain a secure internal clock/timer not tied to a system clock of mobile device 120 to eliminate the possibility of the user preventing a timed security command from executing by resetting the system clock. In another embodiment, the timed security mode can be triggered solely by the occurrence of an event. Thus, rather than specifying a time limit, or by specifying a time limit of zero minutes, client agent 122 can immediately execute a selected security command upon occurrence of a triggering event.

In an embodiment, when the timed security mode is enabled for mobile device 120, server 110 can transmit a one-use password to client agent 122. This password can be stored securely on mobile device 120. In the case of the timed security command being triggered by mobile device 120 failing to communicate with server 110 within the predetermined period of time, mobile device 120 can be prompted to connect to server 110 to prevent the pre-configured timed security command from executing. If mobile device 120 is unable to connect to server 110, an administrator can, upon request, provide the user with the one-use password. The one-use password can reset a clock/timer of mobile device 120, thereby enabling the user to access mobile device 120 as normal. The password can be automatically reset when mobile device 120 connects anew to server 110 to prevent the user from reusing the previously provided password.

In an embodiment, a triggering event can be movement of mobile device 120 within a specified geographic area. Administrator interface 114 can allow the selection or specification of a geographic area where mobile device 120 and/or its sensitive data can be used. If mobile device 120 moves outside of this area, client agent 122 can enter timed security mode. The timed security command can be set to de-activate if mobile device 120 moves back inside the allowed geographic area.

Administrator interface can display a graphical user interface (not shown) comprising a map to facilitate the selection of a geographic area. Alternatively, a city name or state name, for example, can be entered. The geographic area can be any size and can be specified down to various levels depending on the capabilities of an internal geographic location indicator of mobile device 120. In an embodiment, an administrator can specify one or more prohibited geographic areas for mobile device 120, whereby if mobile device 120 enters a prohibited area, the timed security mode is entered. The location of mobile device 120 can be monitored using any system or method that can determine the location of mobile device 120. For example, the global positioning system (GPS), cell phone triangulation, and the like can be used.

In an embodiment, a triggering event can be based on connectivity of the mobile device to one or more specified IP addresses. An administrator can define one or more IP addresses that mobile device 120 must be able to communicate with at all times. If the device moves outside of a network such that it can no longer communicate with the specified IP addresses, client agent 122 can enter timed security mode. The device can also be preset so that when it can communicate with the IP addresses again, the predefined security actions can be automatically reversed.

In an embodiment, server 110 can track and control data moved from a protected device, such as mobile device 120, to a third party device. When specified data is moved or copied from mobile device 120, client agent 122 can replicate itself and transparently move with the data to the third party device. The replicated client agent can install itself on the third party device and, if the third party device has an Internet connection, can report various information to server 110. For example, the replicated client agent can report the name of the device that the data was moved from, the date and time of copying, the name of the device that the data was moved to, the current date and time, the methods used to move the data, and the current location of the third party device. Server 110 can also send a special security command, as discussed above, to the replicated client agent to secure the stolen data on the third party device.

In an embodiment, server 110 can request that client agent 122 perform user surveillance. For example, using a built-in digital camera of mobile device 120, client agent 122 can remotely take a picture or record video of a person using the device and send it to server 110. Using a built-in microphone of mobile device 120, client agent 122 can record audio and send it to server 110. Using a keylogger of mobile device 120, client agent 122 can record keystrokes and other actions performed on mobile device 120 and can report them to server 110. Additionally, the administrator can remotely shadow or control mobile device 120 from workstation 130 or server 110. Specifically, client agent 122 can be configured to record computing actions entered by the user and/or allow for administrator control of mobile device 120. Using these user surveillance features, an administrator can obtain information regarding a user of mobile device 120 and can use the information to determine what security actions should be taken, for example.

The integrated digital camera, microphone, and keylogger can be any of various commercially-available devices. Many laptops and smart phones come with built-in digital cameras and microphones. Additionally, these devices can be any later-developed devices that achieve the necessary functions as discussed above. The keylogger can be implemented in software and/or hardware. The remote shadowing can be implemented similarly to a Virtual Network Computing (VNC) style connection with a remote device. VNC is a desktop sharing system that can permit remote controlling or shadowing of one computer by another computer. An example of a VNC style program is PCAnywhere by Symantec.

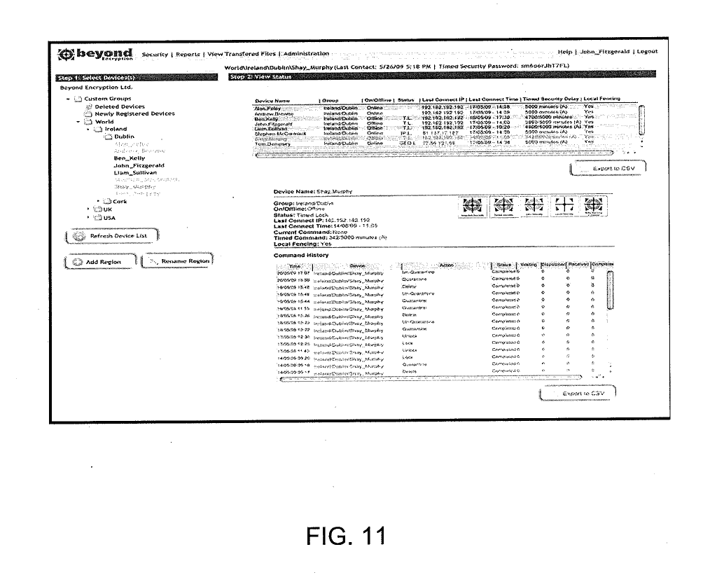

In an embodiment, a comprehensive audit trail can be maintained by administrator interface 114 and/or client agent 122 to support investigative and/or audit requirements. Various events can be recorded and logged, as depicted in FIG. 11 for example, such as a connection log and a command history.

FIG. 12 shows a block diagram of an example of a computing device, which may generally correspond to or illustrate features and capabilities of server 110, mobile device 120, and/or workstation 130. The form of computing device 1200 may be widely varied. For example, computing device 1200 can be a personal computer, workstation, server, handheld computing device, mobile computing device, or any other suitable type of microprocessor-based device. Computing device 1200 can include, for example, one or more components including processor 1210, input device 1220, output device 1230, storage 1240, and communication device 1260. These components may be widely varied, and can be connected to each other in any suitable manner, such as via a physical bus, network line, or wirelessly for example.

For instance, input device 1220 may include a keyboard, mouse, touch screen or monitor, voice-recognition device, or any other suitable device that provides input. Output device 1230 may include, for example, a monitor or other display, printer, disk drive, speakers, or any other suitable device that provides output.

Storage 1240 may include volatile and/or nonvolatile data storage, such as one or more electrical, magnetic or optical memories such as a RAM, cache, hard drive, CD-ROM drive, tape drive or removable storage disk for example. Communication device 1260 may include, for example, a network interface card, modem, or any other suitable device capable of transmitting and receiving signals over a network.

Network 140 may include any suitable interconnected communication system, such as a local area network (LAN) or wide area network (WAN) for example. A network may implement any suitable communications protocol and may be secured by any suitable security protocol. The corresponding network links may include, for example, telephone lines, DSL, cable networks, T1 or T3 lines, wireless network connections, or any other suitable arrangement that implements the transmission and reception of network signals.

Software 1250 can be stored in storage 1240 and executed by processor 1210, and may include, for example, programming that embodies the functionality described in the various embodiments of the present disclosure. The programming may take any suitable form.

Software 1250 can also be stored and/or transported within any computer-readable storage medium for use by or in connection with an instruction execution system, apparatus, or device, such as computing device 1200 for example, that can fetch instructions associated with the software from the instruction execution system, apparatus, or device and execute the instructions. In the context of this document, a computer-readable storage medium can be any medium, such as storage 1240 for example, that can contain or store programming for use by or in connection with an instruction execution system, apparatus, or device.

Software 1250 can also be propagated within any transport medium for use by or in connection with an instruction execution system, apparatus, or device, such as computing device 1200 for example, that can fetch instructions associated with the software from the instruction execution system, apparatus, or device and execute the instructions. In the context of this document, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

One skilled in the relevant art will recognize that many possible modifications and combinations of the disclosed embodiments can be used, while still employing the same basic underlying mechanisms and methodologies. The foregoing description, for purposes of explanation, has been written with references to specific embodiments. However, the illustrative discussions above are not intended to be exhaustive or to limit the disclosure to the precise forms disclosed. Many modifications and variations can be possible in view of the above teachings. The embodiments were chosen and described to explain the principles of the disclosure and their practical applications, and to enable others skilled in the art to best utilize the disclosure and various embodiments with various modifications as suited to the particular use contemplated.

Further, while this specification contains many specifics, these should not be construed as limitations on the scope of what is being claimed or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A method for securing data on a mobile device, comprising:
establishing a remote connection between a server and a mobile device;
receiving at the server a directory listing from the mobile device indicating files and folders stored on the mobile device;
selecting one or more files or folders for securing on the mobile device; and
transmitting from the server a secure command to the mobile device instructing the mobile device to secure the selected one or more files or folders.

2. The method of claim 1, wherein the secure command comprises a quarantine command instructing the mobile device to secure the selected one or more files or folders by encrypting them.

3. The method of claim 2, wherein the quarantine command instructs the mobile device to encrypt the one or more folders or files by using an Advanced Encryption Standard algorithm.

4. The method of claim 2, further comprising transmitting from the server to the mobile device an un-secure command comprising an un-quarantine command instructing the mobile device to decrypt one or more of the selected one or more files or folders.

5. The method of claim 1, wherein the secure command comprises a delete command instructing the mobile device to secure the selected one or more files or folders by deleting them.

6. The method of claim 5, wherein the delete command instructs the mobile device to delete the selected one or more files or folders by overwriting the selected one or more files or folders at least one time with at least one of patterned data and randomized data.

7. The method of claim 6, wherein the delete command complies with the U.S. Department of Defense clearing and sanitizing standard.

8. The method of claim 5, wherein the delete command further instructs the mobile device to delete a system file that temporarily stores file information.

9. The method of claim 8, wherein the system file comprises a virtual page file or a temporary memory image file.

10. The method of claim 1, wherein the secure command comprises a transfer command instructing the mobile device to secure the selected one or more files or folders by transferring them to the server.

11. The method of claim 10, wherein the transfer command further instructs the mobile device to encrypt and compress the selected one or more files or folders before transferring them to the server.

12. The method of claim 1, further comprising selecting a time limit, wherein the secure command instructs the mobile device to secure the selected one or more files or folders after expiration of the selected time limit.

13. The method of claim 1, further comprising selecting a time limit, wherein the secure command instructs the mobile device to secure the selected one or more files or folders if the mobile device remains unconnected from the server for a period longer than the selected time limit.

14. The method of claim 1, further comprising selecting a geographic area, wherein the secure command instructs the mobile device to secure the selected one or more files or folders if the mobile device is not located within the selected geographic area.

15. The method of claim 1, further comprising selecting a geographic area, wherein the secure command instructs the mobile device to secure the selected one or more files or folders if the mobile device is located within the selected geographic area.

16. The method of claim 1, further comprising selecting an Internet Protocol address, wherein the secure command instructs the mobile device to secure the selected one or more files or folders if the mobile device is not connected to the selected Internet Protocol address.

17. The method of claim 1, wherein the mobile device executes the secure command transparently.

18. The method of claim 1, wherein the selecting is performed using a graphical user interface displaying the received directory listing.

19. The method of claim 1, further comprising receiving updates of the directory listing from the mobile device at predetermined intervals.

20. The method of claim 1, wherein if the selected one or more files or folders includes a folder, the secure command instructs the mobile device to secure all of the files within the folder and within any subfolders of the folder.

21. The method of claim 1, wherein if power to the mobile device is interrupted after transmission of the secure command to the mobile device, the mobile device executes the secure command when power to the mobile device is restored.

22. The method of claim 1, wherein at least a portion of the computer code necessary for executing the secure command is not stored locally on the mobile device but is transmitted with the secure command.

23. The method of claim 1, wherein the mobile device replicates a client program stored on the mobile device and transfers the replicated client program along with protected data if the protected data is copied onto a second device.

24. The method of claim 23, wherein the replicated client program installs itself on the second device.

25. The method of claim 24, wherein the replicated client program transmits to the server at least one of a name of the mobile device, a name of the second device, a date and time of copying, a current date and time, a current location of the second device, and a method used to move the copied data.

26. The method of claim 1, further comprising:
transmitting from the server to the mobile device a command instructing the mobile device to take a picture using an integrated digital camera; and
receiving at the server from the mobile device image data representing a picture taken using the integrated camera.

27. The method of claim 1, further comprising:
transmitting from the server to the mobile device a command instructing the mobile device to record video using an integrated digital camera; and
receiving at the server from the mobile device video data representing video recorded using the integrated camera.

28. The method of claim 1, further comprising:
transmitting from the server to the mobile device a command instructing the mobile device to record audio using an integrated microphone; and
receiving at the server from the mobile device audio data representing audio recorded using the integrated microphone.

29. The method of claim 1, further comprising:
transmitting from the server to the mobile device a command instructing the mobile device to record keystrokes using an integrated keylogger; and
receiving at the server from the mobile device data representing keystrokes recorded using the integrated keylogger.

30. The method of claim 1, further comprising:
transmitting from the server to the mobile device a command instructing the mobile device to record computing actions; and
receiving at the server from the mobile device data representing recorded computing actions.

31. A method for securing a mobile device, comprising:
establishing a remote connection between a server and a mobile device; and
transmitting from the server a lock command to the mobile device instructing the mobile device to disable all non-administrative user accounts on the mobile device.

32. The method of claim 31, wherein the lock command further instructs the mobile device to reset a password for an administrator account on the device.

33. The method of claim 31, wherein the lock command further instructs the mobile device to power down.

34. The method of claim 31, further comprising transmitting from the server an unlock command to the mobile device instructing the mobile device to enable the non-administrative user accounts

35. A mobile device, comprising:
a memory configured to store files and folders;
a communication unit configured to connect to a server;
a directory listing module configured to transmit to the server a directory listing indicating the stored files and folders; and
a security module configured to secure one or more of the stored files and folders based on a secure command received from the server.

36. The mobile device of 35, further comprising:
a time unit configured to measure an amount of elapsed time,
wherein the security module is configured to secure the one or more of the stored files and folders if the amount of elapsed time exceeds a predetermined time limit.

37. The mobile device of 35, further comprising:
a geographic location indicator unit configured to identify a current location of the mobile device,
wherein the security module is configured to secure the one or more of the stored files and folders if the identified current location of the mobile device is not within a predetermined geographic area.

38. A system including a server and a mobile device, comprising:
a memory on the mobile device storing files and folders;
a first communication unit on the mobile device configured to transmit to the server a directory listing indicating the files and folders stored on the mobile device;
a user interface on the server configured to display the transmitted directory listing and a plurality of commands and to receive a selection of one or more files or folders indicated by the directory listing and a selection of one of the plurality of commands;
a second communication unit on the server configured to transmit to the mobile device an instruction comprising the selected one or more files or folders and the selected command; and
a client agent on the mobile device configured to secure the selected one or more files or folders by executing the transmitted instruction.
